(19) United States
(12) Patent Application Publication
(10) Pub. No.: US 2017/0300909 A1
(43) Pub. Date: Oct. 19, 2017

(54) SYSTEM AND METHOD FOR SECURE WEB PAYMENTS

(71) Applicants: Parveen Bansal, Foster City, CA (US); Barbara Elizabeth Patterson, Foster City, CA (US); Aparna Krishnan Girish, Foster City, CA (US)

(72) Inventors: Parveen Bansal, Foster City, CA (US); Barbara Elizabeth Patterson, Foster City, CA (US); Aparna Krishnan Girish, Foster City, CA (US)

(21) Appl. No.: 15/489,388

(22) Filed: Apr. 17, 2017

Related U.S. Application Data
(60) Provisional application No. 62/323,148, filed on Apr. 15, 2016.

(51) Int. Cl. G06Q 20/40; G06Q 20/38

(52) U.S. Cl. CPC G06Q 20/405; G06Q 20/3821

(57) ABSTRACT

Systems and methods may facilitate payment transactions between user computer systems and merchant computer systems. An e-commerce enabler system may generate a library of instructions for execution on the user computing device. On execution, the library of instructions may provide payment information for a payment transaction to a merchant e-commerce computer system via a website hosted by the merchant e-commerce computer system. The payment information may correspond to primary account holder data identifying a payment device. The e-commerce enabler system may forward the payment information to a payment network system, create payment payload data from data returned by the payment network system, and forward the payload data to the merchant e-commerce computer system. The merchant e-commerce computer system may then decrypt at least a portion of the payment payload data to complete the payment transaction between the computing device and the merchant e-commerce computer system.

### CROSS REFERENCE TO RELATED APPLICATIONS

This application claims the benefit of U.S. Provisional Patent Application No. 62/323,148, filed on Apr. 15, 2016, the entire disclosure of which is herein incorporated by reference in its entirety.

### FIELD OF TECHNOLOGY

The present disclosure relates to a system and associated methods for securely facilitating payment reconciliation for a transaction between a credit account holder and an e-commerce merchant.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Payment systems allow a user to enter several electronic payment devices into an application. Thereafter, the user may select and use one or more of the payment devices to pay for a transaction by just entering a user name and a password, rather than having to enter all the payment information for each payment device over and over.

More than one payment application may exist. For merchants, each payment application may represent another opportunity for sales but also may represent a requirement to add more programming to their e-commerce site to handle the various payment systems as there is no consistent way for payment applications to interact with e-commerce web sites.

As consumers are increasingly moving their spending behavior from offline to the online world, it is imperative for web payments to be standardized to provide a simple, consistent and convenient way to pay online. However, consumers are increasingly wary of providing their cardholder information to online merchants. E-Commerce Enablers play an important role in forging a trusted relationship with consumers. For example, E-Commerce Enablers may facilitate checkout at merchant sites, collecting card information for payment purposes, and sharing required data with merchants and merchant payment service providers (PSPs).

However, payment flows between various E-Commerce Enablers and merchants/PSPs lack standardization. As a result, consumers must re-type their personal account information and other information for each transaction. Further, customer experiences are varied from one merchant to another despite an identical form of payment used by a customer at each merchant. For example, beginning from the time a consumer chooses to pay at a merchant website, payment across the web today presents customers with non-standard experiences.

### SUMMARY

Features and advantages described in this summary and the following detailed description are not all-inclusive. Many additional features and advantages will be apparent to one of ordinary skill in the art in view of the drawings, specification, and claims hereof. Additionally, other embodiments may omit one or more (or all) of the features and advantages described in this summary.

A common standard for web-based payment solutions may benefit cardholders, e-commerce enablers, merchants, payment service providers, acquirers, and card issuers. Standardizing web-based payments may provide a consistent checkout experience, as well as deliver required transaction information for processing purposes from e-commerce enablers to other entities in the payment flow. Cardholders may benefit from consistent payment experiences, and may be better informed in providing necessary information to complete the payment. With standardized payment information from the e-commerce enablers, merchants may make better decisions about the payment and, thereby, alleviate the need to collecting data from consumers at every single checkout. E-commerce enablers may convert more consumers by delivering a standard payment experience and effectively engage their merchants and PSPs by streamlining the payment flows, and facilitating an easier integration between them. Standardization may also streamline payment flows throughout the payment life-cycle, regardless of whether the E-Commerce Enabler returns payment data with PANs or enables tokenization, thereby returning PANs instead of tokens.

Systems and methods may facilitate payment transactions between user computer systems and merchant computer systems. An e-commerce enabler system may generate a library of instructions for execution on the user computing device. On execution, the library of instructions may provide payment information for a payment transaction to a merchant e-commerce computer system via a website hosted by the merchant e-commerce computer system. The payment information may correspond to primary account holder data identifying a payment device. The e-commerce enabler system may forward the payment information to a payment network system, create payment payload data from data returned by the payment network system, and forward the payload data to the merchant e-commerce computer system. The merchant e-commerce computer system may then decrypt at least a portion of the payment payload data to complete the payment transaction between the computing device and the merchant e-commerce computer system.

### BRIEF DESCRIPTION OF THE DRAWINGS

FIG. 1 is an exemplary system for facilitating web payments;

FIG. 2A and FIG. 2B are different views of an exemplary payment device;

FIG. 3 and FIG. 4A illustrate exemplary process flows for securely facilitating payment reconciliation for a transaction between a credit account holder and an e-commerce merchant;

FIG. 4B illustrates an exemplary checkout graphical user interface;

FIG. 5 illustrates another exemplary process flow for securely facilitating payment reconciliation for a transaction between a credit account holder and an e-commerce merchant;

FIG. 6 illustrates exemplary process flows for tokenizing payment data;

FIG. 7A, FIG. 7B, and FIG. 7C illustrate still further exemplary process flows for securely facilitating payment reconciliation for a transaction between a credit account holder and an e-commerce merchant; and

FIG. 8 illustrates an exemplary computing device used within the systems and methods for securely facilitating payment reconciliation for a transaction between a credit account holder and an e-commerce merchant, as described herein.

Persons of ordinary skill in the art will appreciate that elements in the figures are illustrated for simplicity and clarity so not all connections and options have been shown to avoid obscuring the inventive aspects. For example, common but well-understood elements that are useful or necessary in a commercially feasible embodiment are not often depicted in order to facilitate a less obstructed view of these various embodiments of the present disclosure. It will be further appreciated that certain actions and/or steps may be described or depicted in a particular order of occurrence while those skilled in the art will understand that such specificity with respect to sequence is not actually required. It will also be understood that the terms and expressions used herein are to be defined with respect to their corresponding respective areas of inquiry and study except where specific meanings have otherwise been set forth herein.

### DETAILED DESCRIPTION

The present invention now will be described more fully with reference to the accompanying drawings, which form a part hereof, and which show, by way of illustration, specific exemplary embodiments by which the invention may be practiced. These illustrations and exemplary embodiments are presented with the understanding that the present disclosure is an exemplification of the principles of one or more inventions and is not intended to limit any one of the inventions to the embodiments illustrated. The invention may be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods, systems, computer readable media, apparatuses, or devices. Accordingly, the present invention may take the form of an entirely hardware embodiment, an entirely software embodiment, or an embodiment combining software and hardware aspects. The following detailed description is, therefore, not to be taken in a limiting sense.

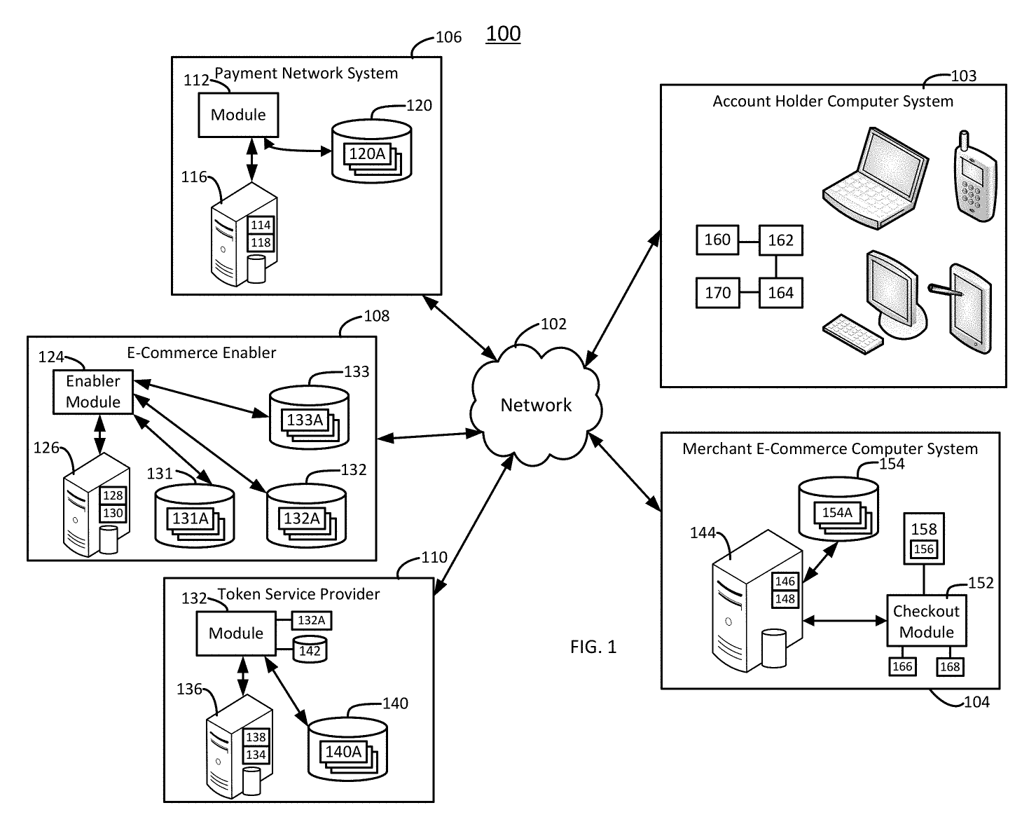

FIG. 1 generally illustrates one embodiment of a system 100 for securely facilitating payment reconciliation between a credit account holder and a merchant. The system 100 may include a computer network 102 that links one or more systems and computer components. In some embodiments, the system 100 includes an account holder computer system 103, a merchant e-commerce computer system 104, a payment network system 106, an e-commerce enabler system 108, and a token service provider 110. The network 102 may be described variously as a communication link, computer network, internet connection, etc. The system 100 may include various software or computer-executable instructions stored on tangible memories and specialized hardware components or modules that employ the software and instructions to securely facilitate payment reconciliation between a credit account holder and a merchant, as described herein. The various modules may be implemented as computer-readable storage memories containing computer-readable instructions (i.e., software) for execution by one or more processors of the system 100 within a specialized or unique computing device. The modules may perform the various tasks, methods, modules, etc., as described herein. The system 100 may also include both hardware and software applications, as well as various data communications channels for communicating data between the various specialized and unique hardware and software components.

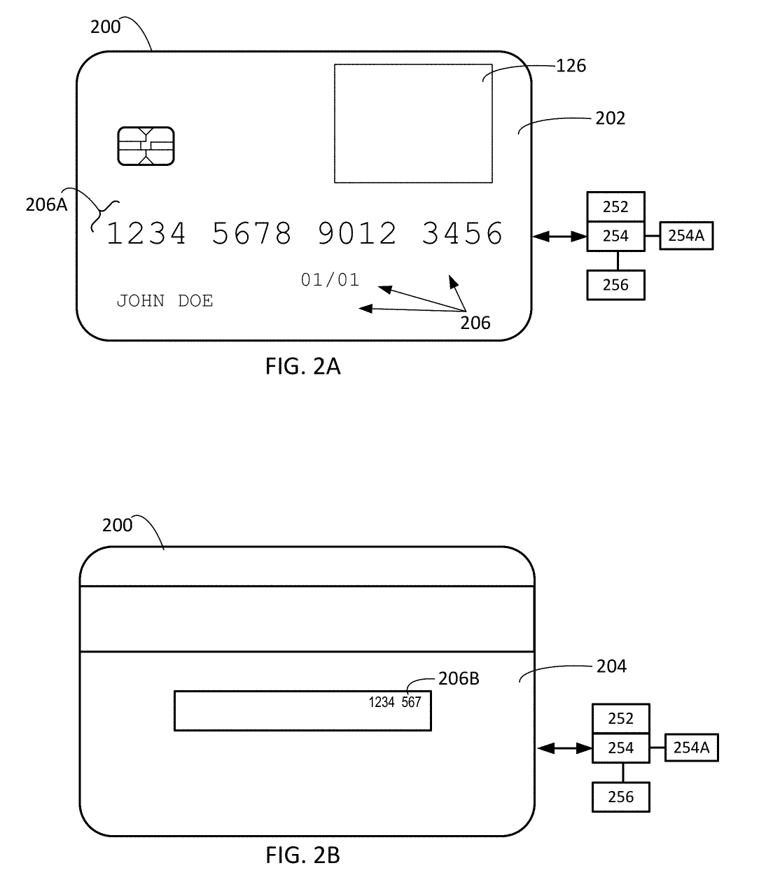

The payment network computer system 106 may include one or more instruction modules including a payment network module 112 that, generally, may include instructions to cause a processor 114 of a payment network computer system server 116 to functionally communicate with a plurality of other computer-executable steps or modules, e.g., modules 112, 124, 135, 152 and components of the system 100 via the network 102. In some embodiments, the module 112 includes instructions to accept, transmit, or process transactions made using a payment device 200 (FIGS. 2A and 2B). The module may also include instructions to transfer information among various entities of the system 100 including payment device issuers, acquirers, merchants, and account holders. These modules 112, 124, 135, 152 may include instructions that, upon loading into the server memory 118 and execution by one or more computer processors 114, securely facilitate payment reconciliation between a credit account holder using a payment device 200 (FIGS. 2A and 2B) and a merchant. A primary account holder data repository 120 may include primary account holder data 120A that each includes various pieces of data to describe an account of a primary account holder and user of the system 100. In some embodiments, primary account holder data 120A or a portion of the primary account holder data 120A (e.g., a personal account number or “PAN”) may be included with a payment device 200.

An e-commerce enabler system 108 may include an e-commerce enabler module 124 that, generally, may include instructions to provide checkout experiences to credit account holders accessing the merchant e-commerce computer system 104 for current and future payment transactions across multiple merchant e-commerce computer systems 106, and, thereby, collect payment information such as payload data 132A (e.g., primary account holder data 120A, data from a payment device 200, token data 140A). The e-commerce enabler system 108 may include an e-commerce enabler server 126 including a processor 128 and memory 130. The module 124 may be loaded onto the memory 130 and the module instructions may be executed by the processor 128. The module 124 may also include instructions to collect payment information for future checkout and payments across multiple merchant e-commerce computer systems 104. In some embodiments, the module 124 may eliminate the need for a user to physically enter payment information for each merchant e-commerce computer system 104. For example, the module 124 may include instructions to provide either card- or token-based payment information to merchants. Instructions of the e-commerce enabler module 124 may include instructions to collect payment information from consumers, provide payment information to various authorized merchant e-commerce computer systems 104, and support other functions (e.g., 3DS, international transactions, etc.).

Further instructions of the e-commerce enabler module 124 may include onboarding of the merchant e-commerce computer system 104 at the e-commerce enabler system 108. Onboarding may include instructions to create an e-commerce merchant account profile 133A for each merchant e-commerce computer system 104, within an account repository 133, associate a profile with each e-commerce merchant account 133A, generate any required API credentials for the e-commerce merchant account profile 133A so that the merchant is authorized to perform transactions with the e-commerce enabler system 108, and generate libraries 131A that are stored within a library repository 131 and communicated to each merchant e-commerce computer system 104 to facilitate payment by the consumer to the merchant via the system 104.

Each library 131A may be a software development kit (e.g., JavaScript SDK) including processor executable instructions to implement the transaction process described herein within the various components of the merchant e-commerce computer system 104. In some embodiments, the libraries 131A include various configurations that may be implemented within the browser of the account holder computing device 103. For example, the library 131A may include instructions to configure a visual list of payment device brands and/or billing countries that are accepted by the merchant e-commerce computer system 104. The library 131A may also include instructions to communicate a list of allowable shipping countries as well as indicate whether shipping information can be changed during checkout or must be selected from an on-file address (e.g., account holder data 120A). The library 131A may also include instructions to implement additional security measures if the merchant e-commerce computer system 104 participates in those measures. For example, the merchant e-commerce computer system 104 may implement an additional security layer for online payment device transactions such as 3DS. In some embodiments, these extra security layers are implemented at the time of the transaction and a payload sent to the merchant e-commerce computer system 104 may include details of any results of the extra security check. Where the 3DS layer is implemented, the payload may include one or more 3DS results such as ECI Raw, CAVV, VERes Timestamp, PARes Status, PARes Timestamp, XID, etc. The merchant e-commerce computer system 104 may then pass these results or other results related to an additional security layer to the payment network system 106 so that it may be used in authorizing a consumer.

In turn, each merchant e-commerce computer system 104 or an authorized entity may include API credentials to perform authorized transactions with the e-commerce enabler system 108. The API credentials include an API key that includes both a key and a shared secret. The merchant e-commerce computer system 104 uses the API key to identify itself to the e-commerce enabler system 108 when sending a transaction request. In some embodiments, the API key includes a combination of alphanumeric characters that are provided to the merchant e-commerce computer system 104 when, for example, the merchant e-commerce computer system 104 created an account profile 133A. The e-commerce enabler system 108 uses the shared secret to confirm the identity of the requestor. Shared secrets are securely stored and never accessible via a webpage, but the API key may be received, activated, deactivated, or deleted. The e-commerce enabler system 108 may include a payload repository 132 for storing payment payload data 132A used in the transactions within the system 100.

The token service provider 110 may include a token service module 135 including instructions that are loaded onto a memory 134 of a token service server 136 and executed by a processor 138 of the server 136. The module 135 instructions may generally, create and provide payment tokens 140A. A token 140A is a replacement for the consumer's account number as it appears on a card or PAN. When enabled for tokenization, the merchant e-commerce computer system 104 may receive a token-based payload that contains a token 140A in place of the full account number. The module 135 may include further instructions as the authorized entity of the system 100 to issue tokens 140A to the various other entities (e.g., the merchant e-commerce computer system 104) of the system 100. In some embodiments, the module 135 may include instructions to maintain organization of a token vault repository 140, generate and issue the payment tokens 140A, apply security measures 135A to the transactions between system entities that include the payment tokens 140A, and create and maintain a token requestor registry 142 to track all history related to the payment tokens 140A. Additionally, the module 124 may include a token requestor API including all provisioning functions. In some embodiments, the module 135 includes an instruction to ensure that any token bank identification number (BIN) corresponding to a payment token 140A is distinct from a personal account number (PAN) corresponding to a primary account holder data 120A.

The merchant e-commerce computer system 104 may include any components that are used by a business to complete an internet-based, e-commerce transaction where a customer uses a payment device 200 to link a payment token 140A other payment data to transactions originating from the account holder computer system 103 or other entity of the system 100. For example, the system 104 may include an e-commerce server 144 having an e-commerce processor 146 and e-commerce memory 148. The memory 148 may include processor-implemented instructions such as a checkout module 152 that is used by the system 104 to gather transaction data 154A, including an amount for a transaction between the account holder computer system 103 and the merchant-commerce computer system 104, customer account information (e.g., a Personal Account Number (“PAN”) 206A and a Card Verification number (“CVN”) 206B), payment token 140A, and primary account holder data 120A from the primary account holder data repository 120. The checkout module 152 may also include instructions to integrate the merchant e-commerce computer system 104 with the e-commerce enabler 108, and render an e-commerce enabler graphic object 156 on a payment webpage 158. In some embodiments, selecting the e-commerce enabler graphic object 156 displayed within the payment webpage 158 will cause the merchant e-commerce computer system 104 to execute instructions of the checkout module 152 to initiate a checkout process, as described herein. The checkout module 152 may also include instructions to request and receive payment information such as payload data 132A (e.g., primary account holder data 120A, token data 140A, etc.) from one or more of the payment network system 106, the ecommerce enabler 108, and the token service provider 110). Other instructions of the checkout module 152 may include instructions to process payments using the payment network system 106. In other embodiments, a system that is authorized by the merchant e-commerce computer system 106 may receive payload data 132A. The merchant e-commerce computer system may store the transaction data 154A within a transaction data repository 154.

The account holder computer system 103 may be a personal computer, mobile computing device (e.g., mobile phone, tablet, etc.) or other computing device that is capable of accessing at least the merchant e-commerce computer system 104 or other entities of the system 100 via the network 102. The account holder computer system 103 may include a processor 160 and memory 162. The memory 162 may include one or more modules (e.g., a payment application 164) including instructions that, when executed by the processor 160 cause the account holder computer system 103 to access the merchant e-commerce computer system 104 or other system entities. In some embodiments, the account holder computer system 103 may complete a purchase transaction by providing information to the e-commerce enabler 108 via the merchant e-commerce computer system 104 to complete a purchase transaction with a payment device 200. In further embodiments, the account holder computer system 103 may include one or more modules such as the payment application 164 that facilitate creating and linking a payment token 140A or other data representing the payment device 200 to transaction data 154A, as described herein.

With brief reference to FIGS. 2A and 2B, an exemplary payment device 200 (FIGS. 2A and 2B) may take on a variety of shapes and forms. In some embodiments, the payment device 200 is a traditional card such as a debit card or credit card. In other embodiments, the payment device 200 may be a fob on a key chain, an NFC wearable, or other device. As long as the payment device 200 is able to communicate securely with the system 100 and the merchant e-commerce computer system 104, the form of the payment device 200 may not be especially critical and may be a design choice for the embodiments described herein. For example, many legacy payment devices may have to be read by a magnetic stripe reader and thus, the payment device 200 may have to be sized to fit through a magnetic card reader. In other examples, the payment device 200 may communicate through near field communication and the form of the payment device 200 may be virtually any form. Of course, other forms may be possible based on the use of the card, the type of reader being used, etc.

Physically, the payment device 200 may be a card and the card may have a plurality of layers to contain the various elements that make up the payment device 200. In one embodiment, the payment device 200 may have a substantially flat front surface 202 and a substantially flat back surface 204 opposite the front surface 202. Logically, in some embodiments, the surfaces 202, 204 may have some embossments 206 including the PAN 206A and the CVN 206B. In some embodiments, the payment device 200 may include data corresponding to the primary account holder, such as a primary account holder data 126A for the primary account holder. A memory 254 generally and a module 254A in particular may be encrypted such that all data related to payment is secure from unwanted third parties. A communication interface 256 may include instructions to facilitate sending payload data 132A to the merchant e-commerce computer system 104, which then passes the payment data/token to the payment processing computer system 106 via the network 102.

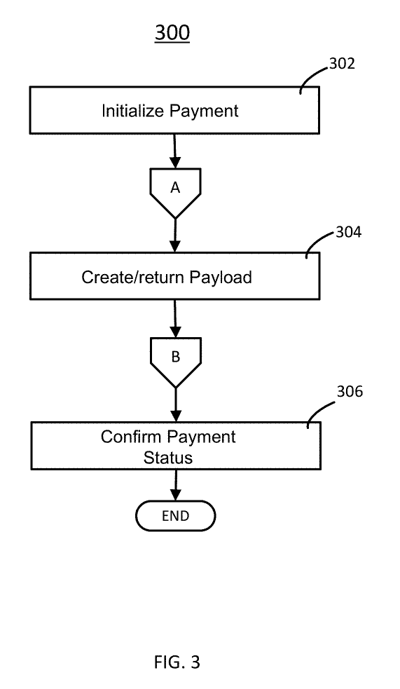

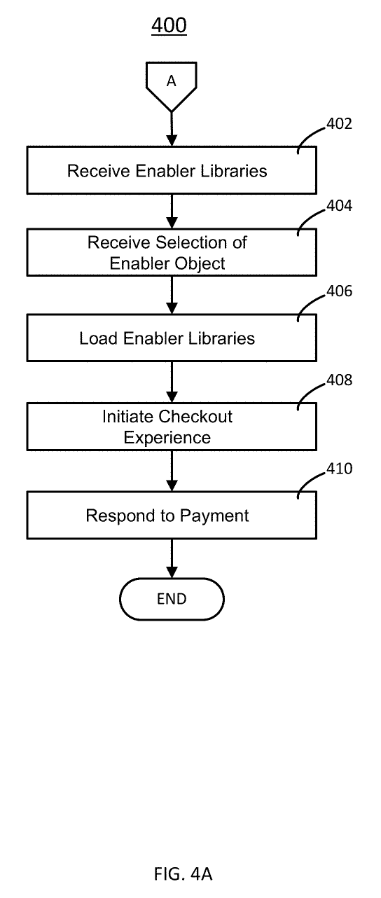

FIG. 3 illustrates a method 300 for securely facilitating payment reconciliation for a transaction between a credit account holder and an e-commerce merchant. Each step of the method may be performed on a server or other computing device including instructions that, when executed by a processor, perform the action or block described herein. The method 300 generally describes the life cycle of web-based payments between consumers and merchants. The life cycle includes three function blocks. At block 302, the method 300 may initialize payment by opening a communication link between the merchant e-commerce computer system 104 and the e-commerce enabler 108 to complete a payment request. At block 304, the method 300 may create and return payload data 132A to an authorized entity requesting the payment (e.g., the merchant e-commerce computer system or an entity authorized by the system). At block 306, the method 300 assumes that the merchant e-commerce computer system 104 or other authorized entity processes the payload received at block 304 and then confirms the status of the payment back to the e-commerce enabler system 108.

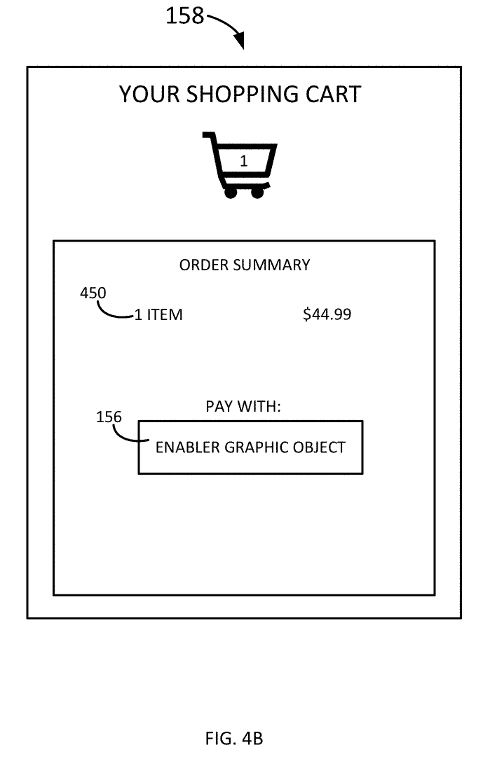

FIG. 4A illustrates a method 400 for securely facilitating payment initialization in a transaction between a credit account holder and an e-commerce merchant. Each step of the method may be performed on a server or other computing device including instructions that, when executed by a processor, perform the action or block described herein. At block 402, the method may receive one or more enabler libraries 131A from the e-commerce enabler system 108. At block 404, the method 400 may receive an indication of a consumer selecting the e-commerce enabler graphic object 156 displayed within a payment webpage 158. In some embodiments, the enabler library 131A received at block 402 may include instructions to render the enabler graphic object 156 within the payment webpage 158. With reference to FIG. 4B, in some embodiments, the account holder computer system 103 may display the payment webpage 158 and the enabler graphic object 156 within a browser executing on the system 103. The enabler graphic object 156 may also include a list of payment devices 200 that are available to complete the transaction, allowed billing countries, and shipping properties to include allowable shipping countries and whether shipping information can be changed during checkout or must be selected from addresses on file with one or more of the payment network system 106, the e-commerce enabler system 108, and the merchant e-commerce computer system 104. Receiving the selection of the enabler graphic object 156 within the webpage 158 for the item 450 may cause the method 400 to execute block 406. For example, at block 406, the method 400 may load one or more enabler libraries 131A received from the e-commerce enabler system 108. At block 408, the method 400 may initiate a checkout experience as defined by the one or more enabler libraries 131A loaded at block 406. In some embodiments, the enabler libraries 131A may cause the webpage 158 to initiate a checkout experience for the consumer viewing the webpage 158 at the account holder computer system 103 (e.g., including the look and feel of the checkout, what payment features must be enabled within the webpage 158, what aspects of the loaded library 131A applies to the particular merchant e-commerce computer system 104, etc.). In some embodiments, the library 131A includes an indication of what language will be used within the webpage 158, a secure logo URL to display, a name associated with the merchant e-commerce computer system 104, an a complete URL to the merchant website. In further embodiments, the library 131A includes shipping settings for display on the webpage 158. For example, the shipping settings may include an indication of accepted countries and whether to obtain a shipping address from the consumer. The library 131A may also include payment settings within the webpage 158. For example, the library 131A may include a merchant's ID associated with the request to the e-commerce enabler system 108, an indication of currency type to be used, an indication of shipping charges and taxes, a discount, gift wrapping availability, a total payment amount, an order ID, description, and promotional codes, and any custom data provided by the merchant e-commerce computer system 104 within the merchant account profile 133A. At block 410, event handlers implemented by one or more of the webpage 158 and the library 131A may respond to submission of a payment indication by the consumer at the account holder computer system 103 and within the experience created by execution of the library 131A loaded at block 406. In some embodiments, event handlers implemented by one or more of the webpage 158 and the library 131A may respond to the payment indication by requesting payment payload data 132A from the e-commerce enabler system 108.

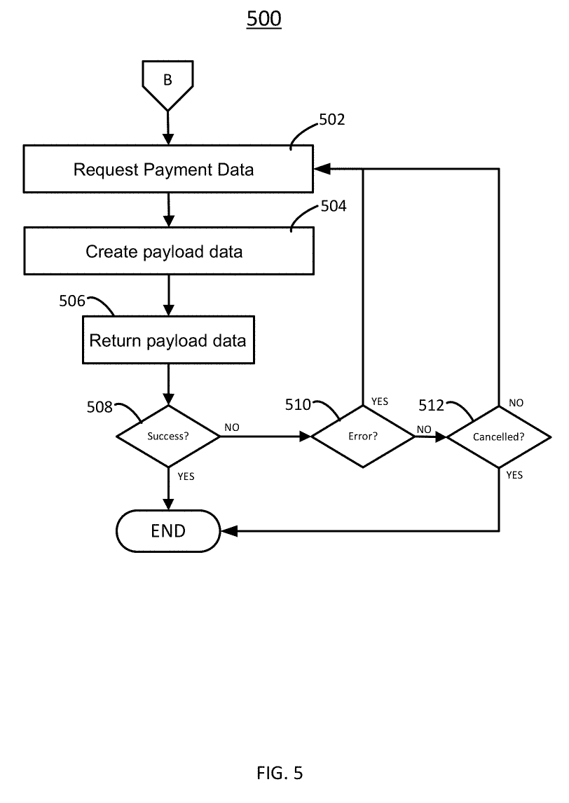

FIG. 5 illustrates a method 500 for securely creating and returning payload data 132A to facilitate payment in a transaction between a credit account holder and an e-commerce merchant. In some embodiments, the e-commerce enabler module 124 includes instructions to return payload data 132A in response to an authorized request from the merchant e-commerce computer system 104. Each step of the method may be performed on a server or other computing device including instructions that, when executed by a processor, perform the action or block described herein.

At block 502, the method 500 may request payload data 132A from the e-commerce enabler system 108 for a transaction initiated at the website 158 by the account holder computer system 103 via the network 102. The request 166 may be communicated from the e-commerce server 144 to the e-commerce enabler server 126 via the network 102. In some embodiments, the request may be communicated any time during or after the purchase transaction such that the merchant e-commerce computer system 104 is able to process transactions smoothly without requiring additional integration efforts. The request 166 may include instructions to receive various types of data from other components of the system in response. For example, the request may include instructions to receive a public API key which is different than the shared secret, an e-commerce enabler system transaction ID associated with a payment request, and a data level that indicates what type of data from one or more of the payment network system 106 and the e-commerce enabler system 108 shall be included with the payload data 132A sent in response to the request 166. In some embodiments, the data level is set by the merchant e-commerce computer system 104 during an on-boarding process with the system 100. For example, the data level may indicate that the e-commerce enabler system 108 may include an instruction to optionally reveal the full PAN only when asked. When tokenizing is enabled, the request 166 may also include instructions to receive a token signature that identifies the token contents and allows the e-commerce enabler system 108 to validate the caller of the request 166. The request 166 may also include instructions to receive a currency type for the payment, a subtotal for the payment, shipping and handling charges, tax, discounts, gift wrap options, uncategorized or miscellaneous charges, a total, an order ID, a merchandise description, a promo code, and any other merchant-supplied data.

Upon receiving the request, the enabler module 124 may execute instructions to create the payload data 132A at block 504. The payload data 132A may include various information for the merchant e-commerce computer system 104 to complete the transaction initiated by the consumer at the account holder computer system 103. For example, the payload data 132A may include a creation time stamp and encrypted payment data. The encrypted payment data may include account holder data 120A (e.g., name, email address, mobile number, URLs to consumer's image, age, gender, etc.), payment instrument information (e.g., cardholder name, PAN, expiration date, CVV2) or token information (token, token expiration information, cryptogram info, etc.), billing information (Name on Card, Billing Address—line 1, line 2, City, State, ZIP, Country, etc.), shipping information (e.g., Name to Ship to, Shipping Address—line 1, line 2, City, State, ZIP, Country, Type of Shipping Location, Notes for the courier, etc.), risk data (AVS Response Code, CVV Response Code, any risk score that the e-commerce enabler system 108 may arrive at, days the account has been active with the e-commerce enabler, specifics of consumer's transaction history, etc.), value added services data (e.g., loyalty program data, gift card data, offer data, rewards, etc.) and 3DS results. In some embodiments, the instructions to create the payload data at block 504 may also include tokenizing the payload data 132A or portions of the payload data 132A.

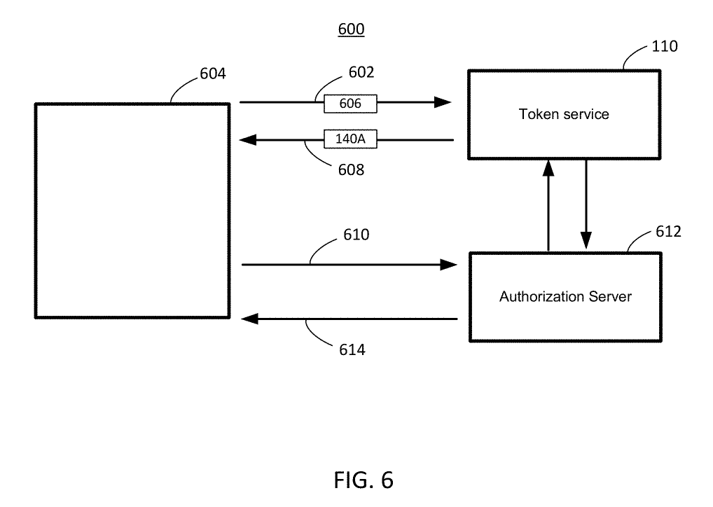

With brief reference to FIG. 6, in some embodiments, a method 600 may convert the payload data 132A, portions of the payload data 132A, or other data used to complete a transaction with the system 100 into a token that represents a PAN and/or other data as herein described. FIG. 6 may illustrate at a high level how tokens may operate to store the primary account holder data 120A, the payload data 132A, or other data for use in transactions between the merchant e-commerce computer system 104 and the account holder computer system 103. In a first step 602, a component 604 of the system 100 such as the enabler module 124 of the e-commerce enabler system 108, the checkout module 152 of the merchant e-commerce computer system 104, or other component may execute instructions to issue a request 606 to a token service provider 110 to receive payment data for a consumer. In a next step 608, a token service provider 110 (e.g., the tokenizing module 135) may generate a response that includes a token 140A. The token 140A may take the place of a personal account number (PAN) or other primary account holder data 120A of the user. The token 140A may be able to be converted by the token service 110 into the PAN, but no other entity could perform the same conversion. In some embodiments, the token 140A includes several fields of data including a token number, a token range including the first nine digits of the token number, a last four including the last four digits of the token number, a token expiration date including month, day, and year, a cryptogram, and an e-commerce indicator. The merchant e-commerce computer system 104 may request via communication 610 authorization on behalf of the customer to an authorization server 612 (i.e., a module of the payment network system 106) using the received token 140A as the payload. The authorization server 612 may request confirmation of the token 140A via communication with the token service 110 and provide an authorization response 614. The token 140A alone may be useless, but the token service 110 may translate the token 140A into a PAN while the PAN may not be exposed over the network 102.

Returning to FIG. 5, at block 506, the method 500 may return the payload data 132A from the e-commerce enabler system 108 to the merchant e-commerce computer system 104. One or more event handlers from the library 131A received by the merchant e-commerce computer system 104 at block 402 may include instructions to determine success, error, or cancellation of the transaction. For example, at block 508, the method 500 may execute an event handler to determine if the payload data 132A was successfully created based on the request of block 502. Block 508 may include instructions to confirm various information within the payload data 132A including: a transaction ID associated with the payment request, an external client ID as received from the entity initializing the payment, a response status (e.g., a HTTPS status, a sub-code corresponding to the e-commerce enabler system 108, a severity indicator, a description of the status, etc.), an encrypted key to be used to decrypt encrypted payment data (i.e., the shared secret may decrypt this key), and the encrypted payment data. If, at block 508, the payload data 132A is not successful, the method may execute instructions to determine whether the payload data 132A included errors at block 510. In some embodiments, payload data 132A that includes an error may fail an HTTPS response status, return an incorrect e-commerce enabler sub-code, of may indicate a severe error along with a description of that error. If the payload data 132A included an error, then the method 500 may return to execute instructions at block 502. If the data did not succeed, but also did not include errors, then at block 512, the method 500 may determine whether the payment transaction was cancelled. In some embodiments, a payment payload 132A for a cancelled transaction may include a transaction ID that indicates cancellation. If the transaction ID does not indicate cancellation, then the method 500 may return to execute instructions at block 502. If the transaction ID indicates cancellation, then the method 500 may end.

The method 500 may encrypt the payment data and payload data 132A according to standards that ensure security of the data. In some embodiments, the method 500 may process the payload data 132A and other data sent and received by elements of the system 100 to ensure secure encryption of transmission and secure storage of encrypted data.

The method 500 may also include instructions to ensure integrity and non-repudiation of sensitive data (if applicable, for data in transit). For example, the method 500 may employ symmetric (e.g., AES-GCM, CBS, CCM) or asymmetric (e.g., PKI) keys. The encryption keys may also be securely protected. The key sizes may be 128-bits or higher (sym), or in an RSA Modulus, 2048-bits or higher (asym). ECC keysize may be 256-bits or higher, as per Industry best practices and protocols. The method 500 may securely transmit the payload data 132A by, for example, two-way SSL to secure communication of personally identifiable information (e.g., cardholder address) as well as personal account identifiers (e.g., token). In some embodiments, this secure transmission may occur by SSL/TLS secure communication, as per Industry best practices and protocols.

The method 500 may also include instructions for controlling authentication and session management. In some embodiments, communications include appropriate authentication methods between applications (e.g., mobile app, web redirects) or between business entities (e.g., client-to-server, server-to-server). In application, the method 500 may control authentication and session management by user name/password, PIN, OAuth 2.0, SAML 2.0, etc., as per Industry best practices and protocols.

The method may also include instructions to employ access control measures that prevent identity attacks. In some embodiments, the method 500 may include instructions for role-based access control, as per Industry best practices.

Returning to FIG. 3, at block 306, the method 300 may confirm payment status. In some embodiments, block 306 includes instructions for the merchant e-commerce computer system 104 to send confirmation data 168 indicating the status of the payload data 132A back to the e-commerce enabler system 108. In further embodiments, an authorized entity of the merchant e-commerce computer system 104 may confirm the payload data 132A. Execution of instructions to confirm payment at block 305 may occur in real time, immediately after the checkout is submitted by the account holder computer system 103 to the merchant e-commerce computer system 104, or at a later time. Confirmation may be made directly from the website 158 of the merchant e-commerce computer system 104 to the e-commerce enabler system 108 by passing parameters in a one-pixel image as provided by the e-commerce enabler system 108. Confirmation may also be made in a server-to-server request (e.g., the e-commerce server 144 to the e-commerce enabler server 126).

Both order and payment status may be communicated by the confirmation data 168 at block 306 and may also include updates that are sent periodically or as information is available to send to the e-commerce enabler system 108. Update data may also be sent for a specific order, as identified by a particular transaction ID. An order status of the confirmation data 168 may include various data including indications that an order was placed, rejected, and/or cancelled, etc. A payment status of the confirmation data 168 may also include various data including indications of success or failure for authorization, settlement, refunds, reversals, chargebacks, etc. The confirmation data 168 may be sent to the e-commerce enabler system 108 in one or many updates based on the nature and type of transaction.

The confirmation data 168 may include any data that indicates the status of the transaction between the merchant e-commerce computer system 104 and the e-commerce enabler system 108. In some embodiments, the confirmation data includes an e-commerce enabler transaction ID associated with a payment request, a public API key that is different than the shared secret, an indication of the currency with which to process the transaction, a total of discounts related to the payment (e.g., a positive value representing the amount to be deducted from the total), an indication of the event associated with the update, a subtotal of the payment, a total of shipping and handling charges in the payment, a total tax-related charges in the payment, a total gift-wrapping charges in the payment, a total uncategorized charges in the payment, a total of the payment including all amounts, a merchant's order ID associated with the payment, a description associated with the payment, a promotion codes associated with the payment, a reason for the update, etc. Where the confirmation data 168 is sent server-to-server and includes a token 140A, the confirmation data 168 may include a token signature identifying the transaction and its contents. Block 306 may include instructions for the e-commerce enabler system to use this signature to validate the caller of a particular request 166.

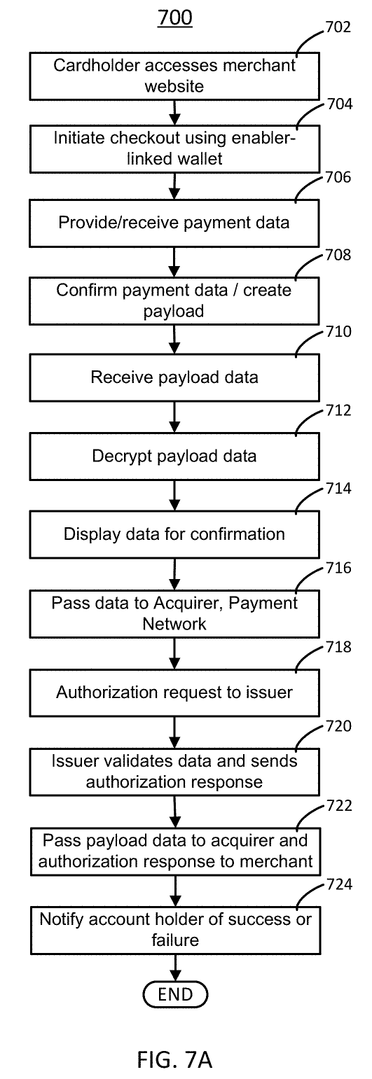

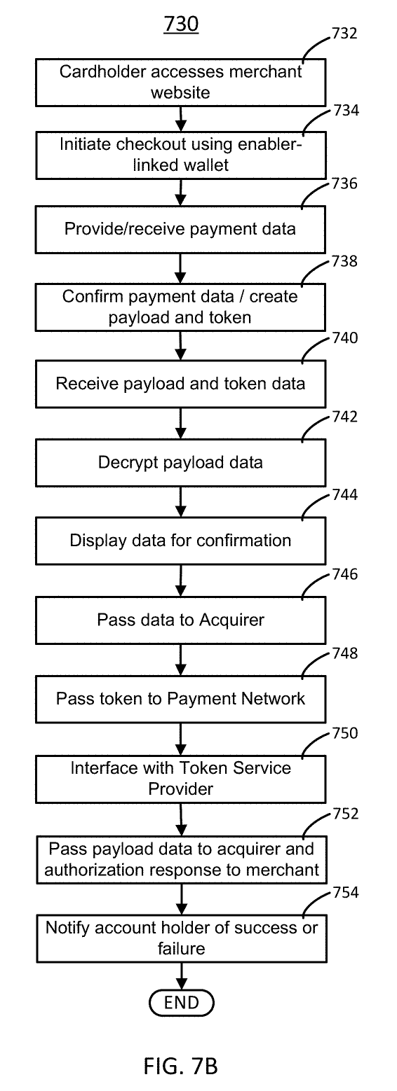

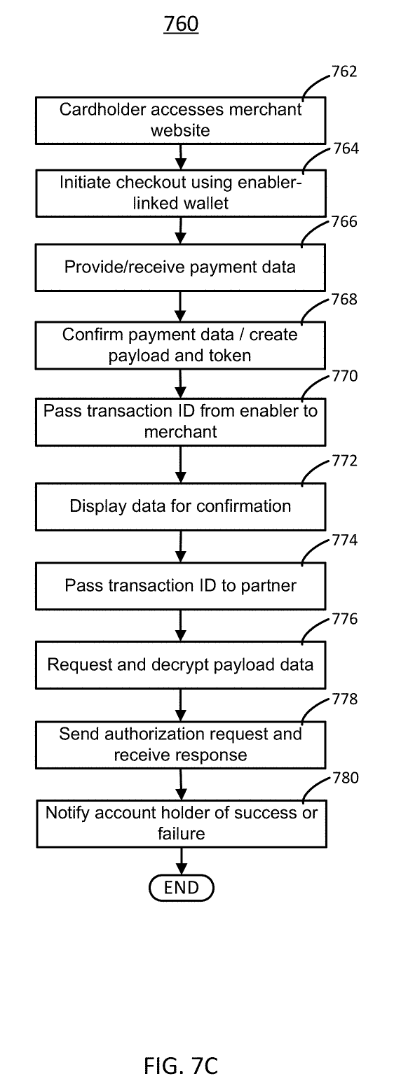

With reference to FIG. 7A, a method 700 may complete an e-commerce transaction within the system 100 using a payment device 200. This method 700 may generally describe a cardholder initiating a payment to an e-commerce site using the e-commerce enabler and a wallet application 170 executing at the account holder computer system 103 to transfer payment and other order information. Generally, the merchant e-commerce computer system 104 or the checkout module 152 may include instructions to perform transaction processing described by the method 700. When the account holder computer system 103 initiates payment at the e-commerce website 158 that supports the wallet application 170, the wallet application may execute instructions to pass the payment data (PAN and other information) to the merchant e-commerce computer system 104. The checkout module 152 may execute instructions to initiate authorizations using the payload data 132A provided by the e-commerce enabler system 108.

At block 702, a payment application 164 may access the website 158 to perform an e-commerce transaction. At block 704, the method 700 may execute instructions to pay for merchant's goods/services using the wallet application 170 that is linked to the e-commerce enabler system 108. At block 706, the method 700 may execute instructions to provide or receive payment data from the account holder computer system 103. In some embodiments, the payment data includes account holder data 120A including a PAN, expiration date, etc., billing and shipping address etc. At block 708, the method 700 may execute instructions to confirm the received payment data using the e-commerce enabler system and also create the payload data 132A. At block 710, the method 700 may execute instructions to receive the payload data 132A from the e-commerce enabler system 108 and, at block 712, decrypt at least a portion of the payload data 132A. At block 714, the method 700 may execute instructions to display a portion of one or more of the decrypted payload data 132A or the payment information for review at the account holder computer system 103. At block 716, the method 700 may then execute instructions to cause the merchant e-commerce computer system 104 to pass an authorization request to an acquirer of the payment network system 106. The acquirer may perform processing checks on the payload data 132A, and, at block 718, the payment network system 106 may pass the authorization request to a bank that issued the payment device 200 used in the transaction. At block 720, the bank may complete an account-level validation and authorization check of the payload data and send an authorization response to the payment network system 106. At block 722, the payment network system 106 may pass at least a portion of the payload data 132A to the acquirer as part of the authorization response with standard data elements, and the acquirer may pass the authorization response to the merchant e-commerce computer system 104. At block 724, the method 700 may execute instructions to notify the account holder computer system of success or failure of the payment transaction.

With reference to FIG. 7B, a method 730 may complete an e-commerce transaction within the system 100 using a token 140A. This method 730 may generally describe a cardholder initiating a payment to an e-commerce site using the e-commerce enabler and a wallet application 170 executing at the account holder computer system 103 to transfer payment and other order information. However, in contrast to the method 700, this method 730 describes the merchant e-commerce computer system as requesting a token 140A rather than a PAN or other data that may directly correspond to the payment device 200. Generally, the e-commerce enabler system 108 may assist in the tokenization process to free the merchant e-commerce computer system 104 from storing the PAN or other sensitive information. Generally, the wallet application 170 may pass a token 140A in lieu of the PAN or other information to the merchant e-commerce computer system 104. The merchant e-commerce computer system 104 may then initiate authorizations using the token 140A.

At block 732, a payment application 164 may access the website 158 to perform an e-commerce transaction. At block 734, the method 730 may execute instructions to pay for merchant's goods/services using the wallet application 170 that is linked to the e-commerce enabler system 108. At block 736, the method 730 may execute instructions to provide or receive payment data from the account holder computer system 103. In some embodiments, the payment data includes account holder data 120A including a PAN, expiration date, etc., billing and shipping address etc. At block 738, the method 730 may execute instructions to confirm the received payment data using the e-commerce enabler system and also create the payload data 132A including a token 140A. Block 738 may also include instructions to generate a cryptogram for the token 140A. At block 740, the method 730 may execute instructions to receive the payload data 132A including the token 140A from the e-commerce enabler system 108 and, at block 742, decrypt at least a portion of the payload data 132A. At block 744, the method 730 may execute instructions to display a portion of one or more of the decrypted payload data 132A or the payment information for review at the account holder computer system 103. At block 746, the method 730 may then execute instructions to cause the merchant e-commerce computer system 104 to pass an authorization request to an acquirer of the payment network system 106. The acquirer may perform processing checks on the payload data 132A, and, at block 748, pass the token 140A to the payment network system 106. At block 750, the payment network system 106 may interface with the token service provider 110 to retrieve the PAN, verify the state of a mapping between the token 140A and the PAN in the token vault repository 140, and other controls that may be defined for the token 140A. The payment network system 106 may also validate the cryptogram for the token 140A and validate a token domain restriction controls for the token 140A. Alternatively, a card issuer may validate the cryptogram if it has the necessary keys. Where the token requestor ID is not included with the token 140A, it may also be retrieved at block 750. At block 752, the method 730 may pass the authorization request to a bank that issued the payment device 200 used in the transaction, the authorization request including the PAN, PAN expiration date, and an indicator that conveys to the issuer bank that an on-behalf-of validation has been completed by the Token Service Provider 110 of the token 140A. In some embodiments, the authorization request to the issuer bank may include the token 140A, a token expiry date, token assurance data, a token assurance level, a token requestor ID, a POS entry mode code, etc. At block 752, the payment network system 106 may replace the PAN with the token 140A based on the mapping, and pass further data to the acquirer as part of the authorization response. For example, the further data may include the payment token 140A, a token assurance level, a last four digits of the PAN, and a PAN product ID. The acquirer may also pass the authorization response to the merchant e-commerce computer system 104. At block 754, the method 730 may execute instructions to notify the account holder computer system of success or failure of the payment transaction.

With reference to FIG. 7C, a method 760 may complete an e-commerce transaction within the system 100 where a merchant e-commerce computer system 104 is integrated with a partner to handle its payment processing or the partner hosts the website 158. A cardholder may initiate payment to the merchant e-commerce computer system 104 via the website 158 using a wallet application 170 to transfer payment and other order information. Additionally, the merchant e-commerce computer system may be integrated to a partner. Within the method 760, the partner performs transaction processing and the merchant may provide their relationship with the partner to the e-Commerce enabler system 108. In the method 760, the assigned partner receives corresponding credentials required to transact with the e-commerce enabler system 108. In this case, the merchant e-commerce computer system 104 assigns the partner as an authorized entity to receive payment data from the e-commerce enabler system 108. The e-commerce enabler system generates the authorized credentials needed for the partner to make transactions on behalf of the merchant. When a cardholder initiates payment at the website 158, the e-commerce enabler system may send an identifier of the payment in the payload data 140A to the merchant e-commerce commuter system 104. The merchant e-commerce computer system 104, not having the infrastructure for business reasons and other rationale to process payments, may pass on this identifier to the partner. Partners can then request the e-commerce enabler system 108 for payload data 140A for the corresponding checkout transaction using the checkout transaction identifier. The e-commerce enabler system 108 authorizes the partner and provides the partner with the payload data 140A. Partners may then initiate authorizations using the payload data 140A provided by the e-commerce enabler.

Where the partner hosts the website 158, the partner also renders the e-commerce enabler graphic object 156, and performs transaction processing. Additionally, the merchant e-commerce computer system provides data identifying the relationship to the partner with the e-commerce enabler system 108. In this case, the assigned partner receives corresponding credentials required to transact with the e-commerce enabler system 108. The partner then enables the merchant e-commerce computer system 104 for using the e-commerce enabler system 108 as a payment option. Partners request payment data from the e-commerce enabler system 108 for the consumer's checkout transaction on behalf of the merchant, and initiate authorizations using the payload data 140A provided by the e-commerce enabler system 108.

At block 762, a payment application 164 may access the website 158 to perform an e-commerce transaction. At block 764, the method 760 may execute instructions to pay for merchant's goods/services using the wallet application 170 that is linked to the e-commerce enabler system 108. At block 766, the method 760 may execute instructions to provide or receive payment data from the account holder computer system 103. In some embodiments, the payment data includes account holder data 120A including a PAN, expiration date, etc., billing and shipping address etc. At block 768, the method 760 may execute instructions to confirm the received payment data using the e-commerce enabler system. At block 770, the method 760 may execute instructions to pass a transaction identifier corresponding to the consumer checkout to the merchant e-commerce computer system 104 from the e-commerce enabler system 108. At block 772, the method 760 may execute instructions to display a portion of one or more of the decrypted payload data 132A or the payment information for review at the account holder computer system 103 for confirmation by the consumer. At block 774, the method 760 may pass the transaction identifier from the merchant e-commerce computer system to the partner. At block 776, the method 760 may then cause the partner to initiate a request for payload data 140A to the e-commerce enabler system 108 and, upon receipt by the partner, decrypt at least a portion of the payload data 140A. At block 778, the method 760 may cause the partner to send an authorization request and receive a response to the authorization request. Generally, at block 778, the partner may perform processing checks on the payload data 140A, and pass the PAN and other account holder data 120A to the payment network system 106. The payment network system 106 may send the authorization request to the issuer bank, and the issuer bank may complete the account-level validation and the authorization checks. The issuer bank may then send an authorization response to the payment network system 106. The payment network system may then pass the required fields to the partner as part of the authorization response with standard data elements. At block 780, the partner may update the e-commerce enabler system 108 on the status of the payment and order.

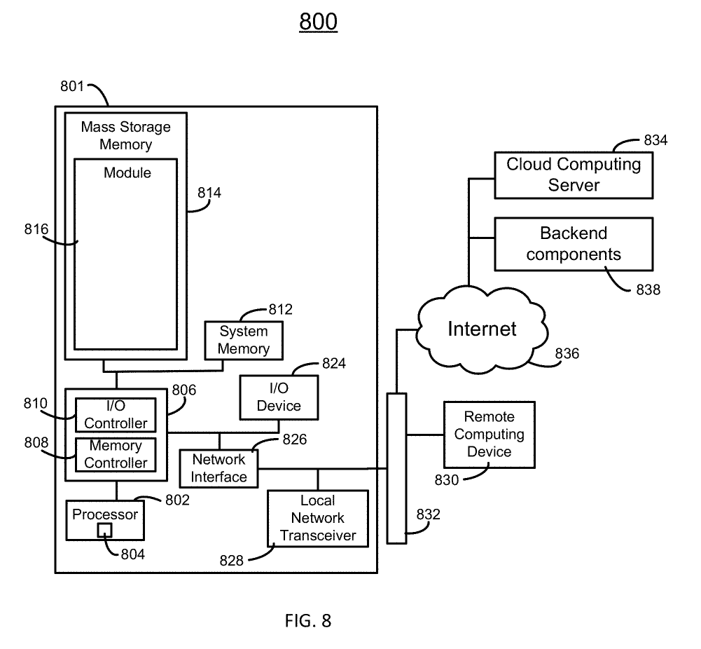

FIG. 8 is a high-level block diagram of an example computing environment 800 for the system and associated methods for securely facilitating payment reconciliation for a transaction between a credit account holder and an e-commerce merchant, as described herein. The computing device 801 may include a server (e.g., servers 116, 126, 136, 144, etc.), a mobile computing device (e.g., account holder computing device 103, a cellular phone, a tablet computer, a Wi-Fi-enabled device or other personal computing device capable of wireless or wired communication), a thin client, or other known type of computing device. As will be recognized by one skilled in the art, in light of the disclosure and teachings herein, other types of computing devices can be used that have different architectures. Processor systems similar or identical to the example system and associated methods for securely facilitating payment reconciliation for a transaction between a credit account holder and an e-commerce merchant may be used to implement and execute the example systems of FIG. 1. Although the example system 800 is described below as including a plurality of peripherals, interfaces, chips, memories, etc., one or more of those elements may be omitted from other example processor systems used to implement and execute the example system described herein. Also, other components may be added.

As shown in FIG. 8, the computing device 801 includes a processor 802 that is coupled to an interconnection bus. The processor 802 includes a register set or register space 804, which is depicted in FIG. 8 as being entirely on-chip, but which could alternatively be located entirely or partially off-chip and directly coupled to the processor 802 via dedicated electrical connections and/or via the interconnection bus. The processor 82 may be any suitable processor, processing unit or microprocessor. Although not shown in FIG. 8, the computing device 801 may be a multi-processor device and, thus, may include one or more additional processors that are identical or similar to the processor 802 and that are communicatively coupled to the interconnection bus.

The processor 802 of FIG. 8 is coupled to a chipset 806, which includes a memory controller 808 and a peripheral input/output (I/O) controller 810. As is well known, a chipset typically provides I/O and memory management functions as well as a plurality of general purpose and/or special purpose registers, timers, etc. that are accessible or used by one or more processors coupled to the chipset 806. The memory controller 808 performs functions that enable the processor 802 (or processors if there are multiple processors) to access a system memory 812 and a mass storage memory 814, that may include either or both of an in-memory cache (e.g., a cache within the memory 812) or an on-disk cache (e.g., a cache within the mass storage memory 814).

The system memory 812 may include any desired type of volatile and/or non-volatile memory such as, for example, static random access memory (SRAM), dynamic random access memory (DRAM), flash memory, read-only memory (ROM), etc. The mass storage memory 814 may include any desired type of mass storage device. For example, if the computing device 801 is used to implement a module 816 (e.g., the various modules for securely facilitating payment reconciliation for a transaction between a credit account holder and an e-commerce merchant, as herein described). The mass storage memory 814 may include a hard disk drive, an optical drive, a tape storage device, a solid-state memory (e.g., a flash memory, a RAM memory, etc.), a magnetic memory (e.g., a hard drive), or any other memory suitable for mass storage. As used herein, the terms module, block, function, operation, procedure, routine, step, and method refer to tangible computer program logic or tangible computer executable instructions that provide the specified functionality to the computing device 801 and the system 800. Thus, a module, block, function, operation, procedure, routine, step, and method can be implemented in hardware, firmware, and/or software. In one embodiment, program modules and routines are stored in mass storage memory 814, loaded into system memory 812, and executed by a processor 802 or can be provided from computer program products that are stored in tangible computer-readable storage mediums (e.g. RAM, hard disk, optical/magnetic media, etc.).

The peripheral I/O controller 810 performs functions that enable the processor 802 to communicate with a peripheral input/output (I/O) device 824, a network interface 826, a local network transceiver 828, (via the network interface 1026) via a peripheral I/O bus. The I/O device 824 may be any desired type of I/O device such as, for example, a keyboard, a display (e.g., a liquid crystal display (LCD), a cathode ray tube (CRT) display, etc.), a navigation device (e.g., a mouse, a trackball, a capacitive touch pad, a joystick, etc.), etc. The I/O device 824 may be used with the module 816, etc., to receive data from the transceiver 828, send the data to the components of the system 100, and perform any operations related to the methods as described herein. The local network transceiver 828 may include support for a Wi-Fi network, Bluetooth, Infrared, cellular, or other wireless data transmission protocols. In other embodiments, one element may simultaneously support each of the various wireless protocols employed by the computing device 801. For example, a software-defined radio may be able to support multiple protocols via downloadable instructions. In operation, the computing device 801 may be able to periodically poll for visible wireless network transmitters (both cellular and local network) on a periodic basis. Such polling may be possible even while normal wireless traffic is being supported on the computing device 801. The network interface 826 may be, for example, an Ethernet device, an asynchronous transfer mode (ATM) device, an 802.11 wireless interface device, a DSL modem, a cable modem, a cellular modem, etc., that enables the system 100 to communicate with another computer system having at least the elements described in relation to the system 100.

While the memory controller 808 and the I/O controller 810 are depicted in FIG. 8 as separate functional blocks within the chipset 806, the functions performed by these blocks may be integrated within a single integrated circuit or may be implemented using two or more separate integrated circuits. The computing environment 800 may also implement the module 816 on a remote computing device 830. The remote computing device 830 may communicate with the computing device 801 over an Ethernet link 832. In some embodiments, the module 816 may be retrieved by the computing device 801 from a cloud computing server 834 via the Internet 836. When using the cloud computing server 834, the retrieved module 816 may be programmatically linked with the computing device 801. The module 816 may be a collection of various software platforms including artificial intelligence software and document creation software or may also be a Java® applet executing within a Java® Virtual Machine (JVM) environment resident in the computing device 801 or the remote computing device 830. The module 816 may also be a “plug-in” adapted to execute in a web-browser located on the computing devices 801 and 830. In some embodiments, the module 816 may communicate with back end components 838 such as the merchant e-commerce computer system 104, the e-commerce enabler system 108, the payment network system 106, and the token service provider 110 of FIG. 1 via the Internet 836.

The system 800 may include but is not limited to any combination of a LAN, a MAN, a WAN, a mobile, a wired or wireless network, a private network, or a virtual private network. Moreover, while only one remote computing device 830 is illustrated in FIG. 8 to simplify and clarify the description, it is understood that any number of client computers are supported and can be in communication within the system 800.

Additionally, certain embodiments are described herein as including logic or a number of components, modules, or mechanisms. Modules may constitute either software modules (e.g., code or instructions embodied on a machine-readable medium or in a transmission signal, wherein the code is executed by a processor) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “some embodiments” or “an embodiment” or “teaching” means that a particular element, feature, structure, or characteristic described in connection with the embodiment is included in at least one embodiment. The appearances of the phrase “in some embodiments” or “teachings” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

Further, the figures depict preferred embodiments for purposes of illustration only. One skilled in the art will readily recognize from the following discussion that alternative embodiments of the structures and methods illustrated herein may be employed without departing from the principles described herein

Upon reading this disclosure, those of skill in the art will appreciate still additional alternative structural and functional designs for the systems and methods described herein through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the systems and methods disclosed herein without departing from the spirit and scope defined in any appended claims.

1. A system for securely completing web-based payment transactions comprising:
a library executing on a computing device, the computing device including a processor and a memory storing the library, the library including processor-executable instructions for providing payment information for a payment transaction to a merchant e-commerce computer system via a website hosted by the merchant e-commerce computer system, the payment information including primary account holder data identifying a payment device; and
an e-commerce enabler system including a processor and a memory, the memory including processor-executable instructions for forwarding the payment information to a payment network system, creating payment payload data from data returned by the payment network system, and forwarding the payment payload data to the merchant e-commerce computer system;
wherein the merchant e-commerce computer system includes a processor and a memory, the memory including processor-executable instructions for decrypting at least a portion of the payment payload data to complete the payment transaction between the computing device and the merchant e-commerce computer system.

2. The system of claim 1, further comprising a payment network computer system including a processor and a memory, the memory including processor-executable instructions for transferring the primary account holder data to the e-commerce enabler system.

3. The system of claim 1, wherein the memory of the e-commerce enabler system further includes processor-executable instructions for onboarding the merchant e-commerce computer system at the e-commerce enabler system.

4. The system of claim 3, wherein the processor-executable instructions for onboarding the merchant e-commerce computer system include processor-executable instructions for creating an e-commerce merchant account profile, generating API credentials for the e-commerce merchant account profile, the credentials authorizing the merchant e-commerce computer system to perform transactions with the e-commerce enabler system, and generating the library, and communicating the library to the merchant e-commerce computer system to facilitate completing the payment transaction.

5. The system of claim 4, wherein the library includes instructions to cause the merchant e-commerce computer system to configure a visual list of payment device brands within the website, wherein the payment device brands are accepted by the merchant e-commerce computer system and to implement additional security measures for forwarding the payment payload data to the merchant e-commerce computer system.

6. The system of claim 1, further comprising a token service provider including a memory and a processor, the memory including processor-executable instructions for creating a token for at least a portion of the payment payload data before forwarding the payload data and the token to the merchant e-commerce computer system.

7. The system of claim 6, wherein the processor-executable instructions for creating the token for at least a portion of the payment payload data include further instructions for ensuring that any token bank identification number (BIN) corresponding to the token is distinct from a personal account number (PAN) corresponding to the primary account holder data.

8. The system of claim 1, wherein the memory of the merchant e-commerce computer system further includes processor-executable instructions for integrating the merchant e-commerce computer system with the e-commerce enabler system, and rendering an e-commerce enabler graphic object on the website.

9. The system of claim 2, wherein the memory of the merchant e-commerce computer system further includes processor-executable instructions for processing payment for the payment transaction using the payment network computer system.

10. The system of claim 1, wherein the memory of the computing device includes further instructions for executing a wallet application to transfer the payment information from the computing device to the merchant e-commerce computing system.

11. A processor-implemented method for securely executing a payment transaction via a computer network, the method comprising:
sending payment information for the payment transaction from a computing device to a merchant e-commerce computer system via a website hosted by the merchant e-commerce computer system, the payment information including primary account holder data identifying a payment device;
securely forwarding the payment information from the merchant e-commerce computer system to an e-commerce enabler system;
creating payment payload data from the payment information and data returned to the e-commerce enabler system from a payment network system; and
decrypting at least a portion of the payment payload data to complete the payment transaction between the computing device and the merchant e-commerce computing system.

12. The method of claim 11, further comprising securely forwarding the payment information from the e-commerce enabler system to the payment network system, wherein the payment network system creates the data returned to the e-commerce enabler system.

13. The method of claim 11, further comprising onboarding the merchant e-commerce computer system at the e-commerce enabler system.

14. The method of claim 13, onboarding the merchant e-commerce computer system at the e-commerce enabler system includes creating an e-commerce merchant account profile, generating API credentials for the e-commerce merchant account profile, the credentials authorizing the merchant e-commerce computer system to perform transactions with the e-commerce enabler system, and communicating a library of processor-executable instructions to the merchant e-commerce computer system to facilitate completing the payment transaction.

15. The method of claim 14, wherein the library includes instructions for configuring a visual list of payment device brands within the website, wherein the payment device brands are accepted by the merchant e-commerce computer system and for implementing additional security measures for forwarding the payment payload data to the merchant e-commerce computer system.

16. The method of claim 11, further comprising creating a token for at least a portion of the payment payload data before forwarding the payment payload data and the token to the merchant e-commerce computer system.

17. The method of claim 16, wherein creating the token for at least a portion of the payment payload data includes ensuring that any token bank identification number (BIN) corresponding to the token is distinct from a personal account number (PAN) corresponding to the primary account holder data.

18. The method of claim 11, integrating the merchant e-commerce computer system with the e-commerce enabler system, and rendering an e-commerce enabler graphic object on the website.

19. The method of claim 12, further comprising processing payment for the payment transaction using a payment network computer system.

20. The method of claim 11, further comprising executing a wallet application to transfer the payment information from the computing device to the merchant e-commerce computing system.
